(19) United States
(12) Patent Application Publication
(10) Pub. No.: US 2014/0111445 A1
(43) Pub. Date: Apr. 24, 2014

(54) CURSOR CONTROL DEVICE AND CURSOR CONTROL SYSTEM

(71) Applicant: PRIMAX ELECTRONICS LTD., Neihu (TW)

(72) Inventors: Shih-Chieh Lan, Neihu (TW); Ying-Che Tseng, Neihu (TW)

(73) Assignee: PRIMAX ELECTRONICS LTD., Neihu (TW)

(21) Appl. No.: 13/707,392

(22) Filed: Dec. 6, 2012

(30) Foreign Application Priority Data
Oct. 19, 2012 (TW) 101138692

(51) Int. Cl. G06F 3/041

(52) U.S. Cl. CPC G06F 3/041
USPC 345/173

(57) ABSTRACT

A cursor control system includes a cursor control device and a computer host. The cursor control device includes an operating plate, a blood vessel sensing unit, and a controlling unit. The operating plate is used for placing a palm and a finger of a user thereon. The blood vessel sensing unit is used for detecting the finger at different positions, thereby acquiring plural blood vessel images of the finger. According to the plural blood vessel images, a finger displacement amount is acquired by the controlling unit. In addition, a cursor moving signal corresponding to the finger displacement amount is transmitted from the controlling unit to the computer host. According to the cursor moving signal, the cursor is correspondingly moved.

### FIELD OF THE INVENTION

The present invention relates to an input device, and more particularly to a cursor control device for controlling a computer host to move a cursor.

### BACKGROUND OF THE INVENTION

The widely-used cursor control device includes for example a mouse, a trackball or a touchpad. Among these cursor control devices, the mouse is the most prevailing because it is very easy-to-use for most users. When a mouse is held by the palm of a user, the user may move the mouse to control movement of a cursor shown on a computer monitor.

Hereinafter, the structures and the functions of a conventional mouse will be illustrated with reference to FIG. 1. FIG. 1 schematically illustrates the connection between a conventional mouse and a computer system. As shown in FIG. 1, the computer system 2 comprises a computer host 21 and a computer monitor 22. The computer host 21 is in communication with a wheel mouse 1 and the computer monitor 22. The computer host 21 has a connecting port 211. The connecting port 211 is connected with the wheel mouse 1. Moreover, a graphic-based window 221 and a cursor 222 are shown on the computer monitor 22. The wheel mouse 1 is used for controlling the cursor 222 to have the computer host 21 execute a corresponding command. The wheel mouse 1 comprises a casing 10, a left button 11, a right button 12, and a scroll wheel 13. The casing 10 is used for supporting a user's palm P (see FIG. 2). When the casing 10 is moved by the user, the casing 10 generates a displacement amount. According to the displacement amount, the cursor 222 shown on the computer monitor 22 is correspondingly moved by the computer host 21. By clicking the left button 11 or the right button 12, a corresponding button signal is issued to the computer host 21. According to the button signal, the computer host 21 executes a corresponding command. The scroll wheel 13 is arranged between the left button 11 and the right button 12. By rotating the scroll wheel 13, a corresponding scrolling signal is generated. According to the scrolling signal, the graphic-based window 221 shown on the computer monitor 22 may be scrolled upwardly or downwardly by the computer host 21.

FIG. 2 schematically illustrates the outward appearance of a conventional mouse in a usage status. For operating the conventional mouse 1, the user's palm P should be firstly placed on the casing 10 while a first finger F1 is placed on the left button 11 and a second finger F2 is placed on the right button 12. Consequently, the user may start to operate the mouse 1. Moreover, during operations of the conventional mouse 1, the conventional mouse 1 should be placed on a flat working surface. After the conventional mouse 1 is placed on the flat working surface, the mouse may be moved to generate the displacement amount. According to the displacement amount, the cursor 222 shown on the computer monitor 22 is correspondingly moved.

The conventional mouse 1, however, still has some drawbacks. For example, the mouse 1 should be held by the hand gesture as shown in FIG. 2, and the mouse 1 should be placed on a flat working surface during operations. Due to the hand gesture, the user's wrist is maintained in a floating state. After the mouse 1 has been used for a long term, the user is readily suffered from wrist fatigue or even suffered from wrist muscle injury.

Therefore, there is a need of providing a cursor control device for reducing the fatigue of the user's wrist.

### SUMMARY OF THE INVENTION

The present invention provides a cursor control device and a cursor control system for reducing the fatigue of the user's wrist during operations.

In accordance with an aspect of the present invention, there is provided a cursor control device. The cursor control device is in communication with a computer host for controlling a cursor of the computer host. The cursor control device includes an operating plate, a first blood vessel sensing unit, and a controlling unit. The operating plate is used for placing a palm and a first finger of a user thereon. The first finger includes plural first blood vessels. The first blood vessel sensing unit is disposed on the operating plate for detecting the first finger at different positions, thereby acquiring plural blood vessel images of the first finger. A first blood vessel image of the plural blood vessel images of the first finger is acquired by the first blood vessel sensing unit when the first finger at a first position is detected. A second blood vessel image of the plural blood vessel images of the first finger is acquired by the first blood vessel sensing unit when the first finger at a second position is detected. The controlling unit is disposed within the operating plate and connected with the first blood vessel sensing unit. The controlling unit acquires a first finger displacement amount of the first finger according to the first blood vessel image of the first finger and the second blood vessel image of the first finger. A cursor moving signal is generated by the controlling unit according to the first finger displacement amount. The cursor is moved by the computer host according to the cursor moving signal.

In an embodiment, the first blood vessel sensing unit includes a first light-emitting element and a first image sensor. The first light-emitting element is used for emitting a first infrared light beam to the first finger. The first image sensor is connected with the controlling unit for receiving the first infrared light beam reflected from the first finger, thereby acquiring the plural blood vessel images of the first finger. When the first finger is at the first position and the first infrared light beam is projected on the first finger, a first portion of the first infrared light beam within a first wavelength range is absorbed by the plural first blood vessels of the first finger, and a second portion of the first infrared light beam beyond the first wavelength range is reflected from the plural first blood vessels of the first finger. After the second portion of the first infrared light beam reflected from the plural first blood vessels of the first finger is received by the first image sensor, the first blood vessel image of the first finger is produced by the first image sensor. The first blood vessel image of the first finger is imaged according to the absorbed first portion of the first infrared light beam within the first wavelength range.

In an embodiment, when the first finger is moved from the first position to the second position along a first direction and the first blood vessel image of the first finger and the second blood vessel image of the first finger are generated by the first image sensor, the controlling unit acquires the first finger displacement amount corresponding to the first direction by comparing the first blood vessel image of the first finger with the second blood vessel image of the first finger, and the controlling unit generates the cursor moving signal corresponding to the first direction.

In an embodiment, when the first finger is moved from the first position to the second position along a first direction and the first blood vessel image of the first finger and the second blood vessel image of the first finger are generated by the first image sensor, the controlling unit acquires the first finger displacement amount corresponding to the first direction by comparing the first blood vessel image of the first finger with the second blood vessel image of the first finger, and the controlling unit generates the cursor moving signal corresponding to a second direction, wherein the second direction is perpendicular to the first direction.

In an embodiment, the cursor control device further includes a second blood vessel sensing unit. The second blood vessel sensing unit is disposed on the operating plate and located beside the first blood vessel sensing unit for detecting a second finger of the user at different positions, thereby acquiring plural blood vessel images of the second finger. A third blood vessel image of the plural blood vessel images of the second finger is acquired by the second blood vessel sensing unit when the second finger at a third position is detected. A fourth blood vessel image of the plural blood vessel images of the second finger is acquired by the second blood vessel sensing unit when the second finger at a fourth position is detected.

In an embodiment, the controlling unit is further connected with the second blood vessel sensing unit. The controlling unit acquires a second finger displacement amount of the second finger by comparing the third blood vessel image of the second finger with the fourth blood vessel image of the second finger. A window scrolling signal is generated by the controlling unit according to the second finger displacement amount. In addition, a window scrolling command is executed by the computer host according to the window scrolling signal. The second blood vessel sensing unit includes a second light-emitting element and a second image sensor. The second light-emitting element is used for emitting a second infrared light beam to the second finger. The second image sensor is connected with the controlling unit for receiving the second infrared light beam reflected from the second finger, thereby acquiring the plural blood vessel images of the second finger. When the second finger is at the third position and the second infrared light beam is projected on the second finger, a first portion of the second infrared light beam within a first wavelength range is absorbed by the plural second blood vessels of the second finger, and a second portion of the second infrared light beam beyond the first wavelength range is reflected from the plural second blood vessels of the second finger. After the second portion of the second infrared light beam reflected from the plural second blood vessels of the second finger is received by the second image sensor, the third blood vessel image of the second finger is produced by the second image sensor. The third blood vessel image of the second finger is imaged according to the absorbed first portion of the second infrared light beam within the second wavelength range.

In an embodiment, the cursor control device further includes a first button and a second button. The first button is disposed on the operating plate and electrically connected with the controlling unit. When the first button is pressed by a third finger of the user, the first button issues a first button code to the controlling unit. The second button is disposed on the operating plate and electrically connected with the controlling unit. When the second button is pressed by a fourth finger of the user, the second button issues a second button code to the controlling unit. When the first button code is received by the controlling unit, a first button signal corresponding to the first button code is transmitted from the controlling unit to the computer host, so that the computer host executes a first button command according to the first button signal. When the second button code is received by the controlling unit, a second button signal corresponding to the second button code is transmitted from the controlling unit to the computer host, so that the computer host executes a second button command according to the second button signal.

In accordance with another aspect of the present invention, there is provided a cursor control system. The cursor control system includes a computer host and a cursor control device. The computer host includes a cursor. A database program is installed in the computer host. A finger database is established within the computer host by executing the database program. The cursor control device is in communication with the computer host for controlling the cursor. The cursor control device includes an operating plate, a first blood vessel sensing unit, and a controlling unit. The operating plate is used for placing a palm and a first finger of a user thereon. The first finger includes plural first blood vessels. The first blood vessel sensing unit is disposed on the operating plate for detecting the first finger at different positions, thereby acquiring plural blood vessel images of the first finger. A first blood vessel image of the plural blood vessel images of the first finger is acquired by the first blood vessel sensing unit when the first finger at a first position is detected. The controlling unit is disposed within the operating plate and connected with the first blood vessel sensing unit and the computer host. The controlling unit issues a cursor moving signal to the computer host according to the plural blood vessel images of the first finger, so that the cursor is moved by the computer host according to the cursor moving signal, or the controlling unit transmits the first blood vessel image of the first finger to the computer host. After the first blood vessel image of the first finger is received by the computer host, the database program analyzes the first blood vessel image of the first finger to acquire a blood vessel message corresponding to the first blood vessel image, and the database program assigns a user code to the blood vessel message. Moreover, the user code and the blood vessel message are further stored in the finger database.

In an embodiment, a second blood vessel image of the plural blood vessel images of the first finger is acquired by the first blood vessel sensing unit when the first finger at a second position is detected. The controlling unit acquires a first finger displacement amount of the first finger by comparing the first blood vessel image of the plural blood vessel images with the second blood vessel image. The cursor moving signal is generated by the controlling unit according to the first finger displacement amount. In addition, the cursor is moved by the computer host according to the cursor moving signal.

In an embodiment, a predetermined cursor movement distance is previously stored in the controlling unit. When the first finger is moved from the first position to a terminal position along a first direction and a terminal blood vessel image of the first finger is acquired by the first blood vessel sensing unit, the controlling unit acquires a maximum displacement amount by comparing the first blood vessel image of the first finger with the terminal blood vessel image of the first finger, and the controlling unit assigns the predetermined cursor movement distance to the maximum displacement amount. After the first finger displacement amount is acquired by the controlling unit, the controlling unit compares the first finger displacement amount with the maximum displacement amount, thereby acquiring a displacement ratio. In addition, the controlling unit acquires the cursor moving signal according to the displacement ratio and the predetermined cursor movement distance.

In an embodiment, the cursor control device further includes a second blood vessel sensing unit. The second blood vessel sensing unit is disposed on the operating plate and located beside the first blood vessel sensing unit. The second blood vessel sensing unit is connected with the controlling unit for detecting a second finger of the user at different positions, thereby acquiring plural blood vessel images of the second finger. The controlling unit acquires a second finger displacement amount according to the plural blood vessel images of the second finger. The controlling unit issues a window scrolling signal to the computer host according to the second finger displacement amount. The computer host executes a window scrolling command according to the window scrolling signal. A third blood vessel image of the plural blood vessel images of the second finger is acquired by the second blood vessel sensing unit when the second finger at a third position is detected. A fourth blood vessel image of the plural blood vessel images of the second finger is acquired by the second blood vessel sensing unit when the second finger at a fourth position is detected.

In an embodiment, a predetermined window movement distance is previously stored in the controlling unit. When the second finger is moved from the third position to a terminal position along a first direction and a terminal blood vessel image of the second finger is acquired by the second blood vessel sensing unit, the controlling unit acquires a maximum displacement amount by comparing the third blood vessel image of the second finger with the terminal blood vessel image of the second finger, and the controlling unit assigns the predetermined window movement distance to the maximum displacement amount. After the second finger displacement amount is acquired by the controlling unit, the controlling unit compares the second finger displacement amount with the maximum displacement amount, thereby acquiring a displacement ratio. In addition, the controlling unit acquires the window scrolling signal according to the displacement ratio and the predetermined window movement distance.

In an embodiment, when a first finger of an additional user at the first position is detected by the first blood vessel sensing unit, a first blood vessel image of the first finger of the additional user is acquired by the first blood vessel sensing unit, and the first blood vessel image of the first finger of the additional user is transmitted from the controlling unit to the computer host. After the first blood vessel image of the first finger of the additional user is received by the computer host, the database program analyzes the first blood vessel image of the first finger of the additional user to acquire an additional blood vessel message corresponding to the additional blood vessel image of the first finger of the additional user, and the database program assigns an additional user code to the additional blood vessel message. The additional user code and the additional blood vessel message are further stored in the finger database.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is schematically illustrates the connection between a conventional mouse and a computer system;

FIG. 2 schematically illustrates the outward appearance of a conventional mouse in a usage status;

FIG. 3 schematically illustrates the connection between a cursor control device and a computer system of a cursor control system according to a first embodiment of the present invention;

FIG. 4 schematically illustrates the hand gesture of operating the cursor control device according to the first embodiment of the present invention, in which a first finger is at a first position and a second finger is at a third position;

FIG. 5 schematically illustrates a first blood vessel sensing unit of the cursor control device according to the first embodiment of the present invention;

FIG. 6 schematically illustrates a first blood vessel image of a first finger acquired by a first blood vessel sensing unit of the cursor control device according to the first embodiment of the present invention;

FIG. 7 schematically illustrates the hand gesture of operating the cursor control device according to the first embodiment of the present invention, in which the first finger is moved to a second position;

FIG. 8 schematically illustrates a second blood vessel image of a first finger acquired by a first blood vessel sensing unit of the cursor control device according to the first embodiment of the present invention;

FIG. 9 schematically illustrates a cursor control system according to a second embodiment of the present invention;

FIG. 10 schematically illustrates the hand gesture of operating the cursor control device according to the second embodiment of the present invention, in which a first finger is at a first position and a second finger is at a third position;

FIG. 11 schematically illustrates a finger database of the cursor control device according to the second embodiment of the present invention;

FIG. 12 schematically illustrates the hand gesture of operating the cursor control device according to the second embodiment of the present invention, in which the first finger is moved to a terminal position;

FIG. 13 schematically illustrates the hand gesture of operating the cursor control device according to the second embodiment of the present invention, in which the first finger is moved to a second position; and

FIG. 14 schematically illustrates the hand gesture of an additional user of operating the cursor control device according to the second embodiment of the present invention.

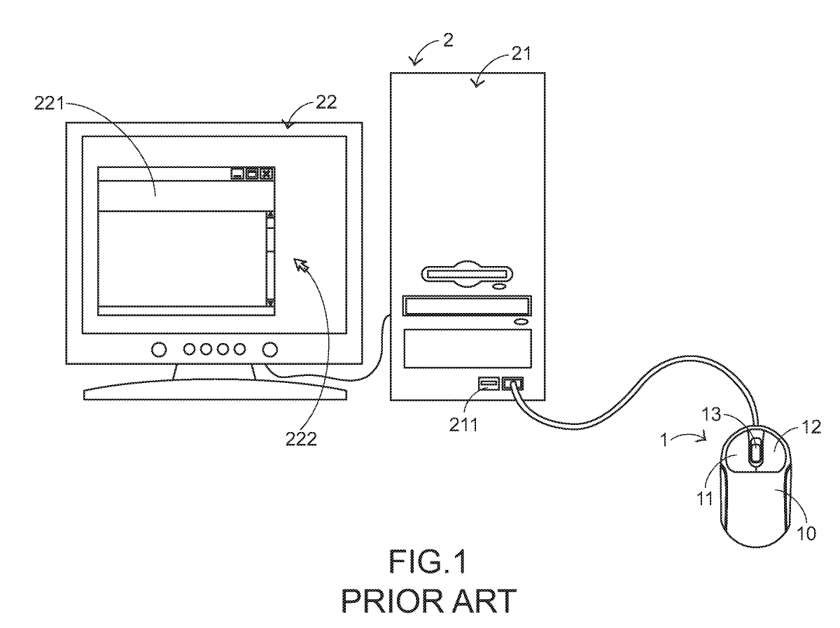

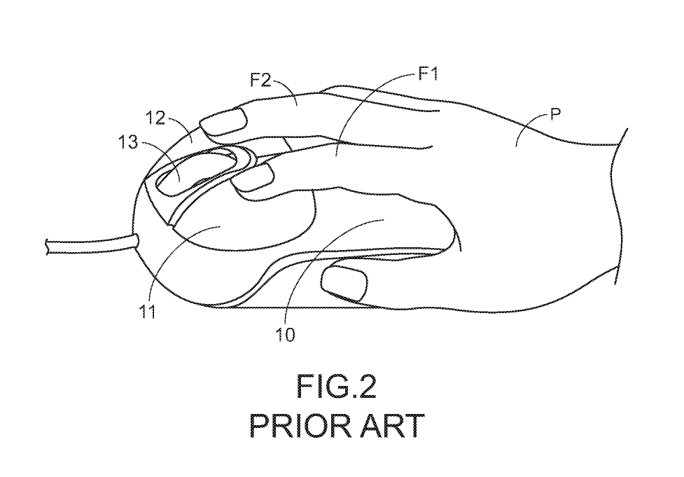

### DETAILED DESCRIPTION OF THE PREFERRED EMBODIMENT

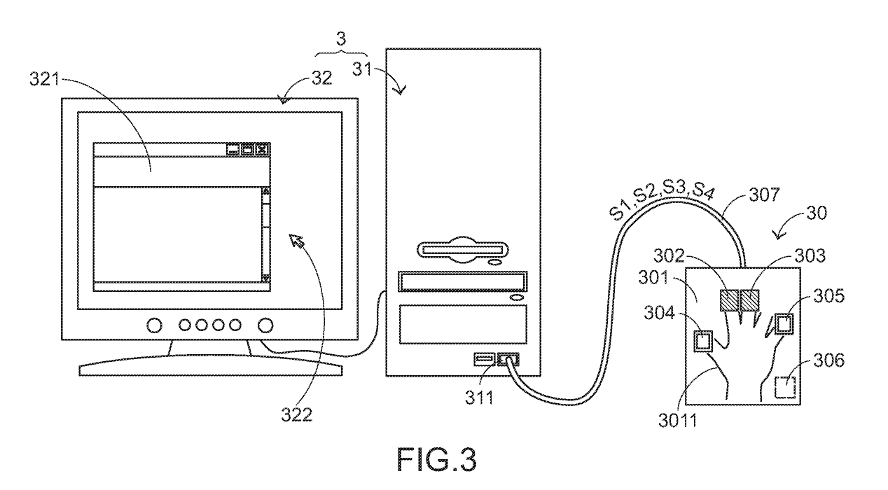

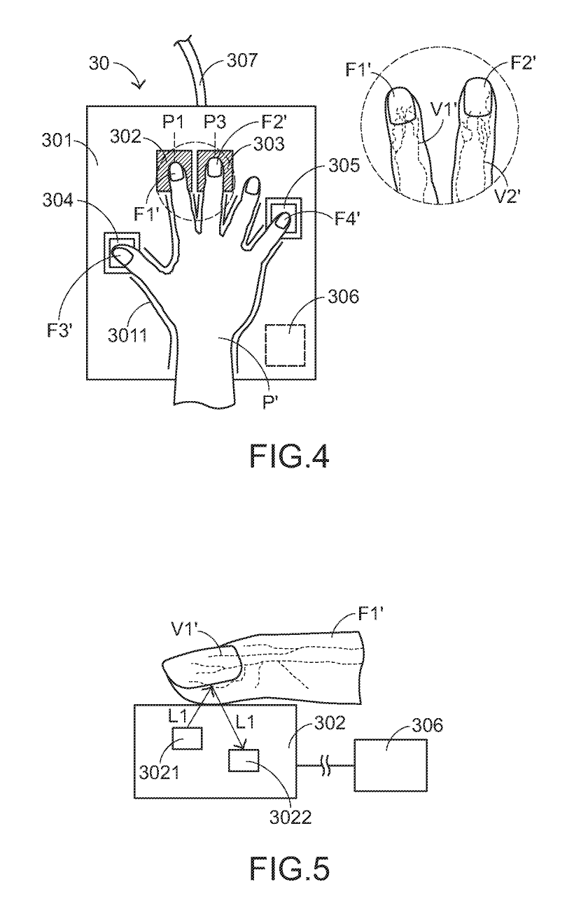

FIG. 3 schematically illustrates the connection between a cursor control device and a computer system of a cursor control system according to a first embodiment of the present invention. FIG. 4 schematically illustrates the hand gesture of operating the cursor control device according to the first embodiment of the present invention, in which a first finger is at a first position and a second finger is at a third position. Please refer to FIGS. 3 and 4. The cursor control device 30 is in communication with a computer system 3. The computer system 3 comprises a computer host 31 and a computer monitor 32. The computer host 31 is in communication with the cursor control device 30 and the computer monitor 32. The computer host 31 comprises a connecting port 311. The connecting port 311 is connected with the cursor control device 30. Moreover, a graphic-based window 321 and a cursor 322 are shown on the computer monitor 32. The cursor control device 30 is used for controlling the graphic-based window 321 and a cursor 322 shown on the computer monitor 32. In this embodiment, the cursor control device 30 comprises an operating plate 301, a first blood vessel sensing unit 302, a second blood vessel sensing unit 303, a first button 304, a second button 305, a controlling unit 306, and a connecting wire 307. The connecting wire 307 is disposed on the operating plate 301. After the connecting wire 307 is connected with the connecting port 311 of the computer host 31, the cursor control device 30 is in communication with the computer host 31. In this embodiment, the cursor control device 30 is in communication with the computer host 31 through the connecting wire 307. Alternatively, in some other embodiments, the cursor control device further comprises a wireless transmission module for transmitting a wireless signal, and a wireless signal receiver is plugged into the connecting port of the computer host. Under this circumstance, the cursor control device is in communication with the computer host through the wireless transmission module and the wireless signal receiver.

Moreover, the operating plate 301 of the cursor control device 30 is a flat plate. A palm P′, a first finger F1′, a second finger F2′, a third finger F3′ and a fourth finger F4′ of a user may be placed on the operating plate 301. The first finger F1′ comprises plural first blood vessels V1′. The second finger F2′ comprises plural second blood vessels V2′. The operating plate 301 has a palm pattern 3011. The palm pattern 3011 is an alignment mark for facilitating alignment of the palm P′, the first finger F1′, the second finger F2′, the third finger F3′ and the fourth finger F4′ of the user. By the palm pattern 3011, the palm P′ of the user can be placed on a fixed position of the operating plate 301 at each time (see FIG. 4). In this embodiment, the first finger F1′ is an index finger, the second finger F2′ is a middle finger, the third finger F3′ is a thumb and the fourth finger F4′ is a little finger.

Please refer to FIGS. 3 and 4 again. The first blood vessel sensing unit 302 is disposed on the operating plate 301, and electrically connected with the controlling unit 306. The first blood vessel sensing unit 302 is used for detecting plural blood vessel images of the plural first blood vessels V1′ of the first finger F1′ at different positions. The second blood vessel sensing unit 303 is disposed on the operating plate 301, and electrically connected with the controlling unit 306. Moreover, the second blood vessel sensing unit 303 is located beside the first blood vessel sensing unit 302. The second blood vessel sensing unit 303 is used for detecting plural blood vessel images of the plural second blood vessels V2′ of the second finger F2′ at different positions. The first button 304 is disposed on the operating plate 301, and electrically connected with the controlling unit 306. When the first button 304 is pressed by the third finger F3′ of the user, the first button 304 issues a first button code to the controlling unit 306. The second button 305 is disposed on the operating plate 301, and electrically connected with the controlling unit 306. When the second button 305 is pressed by the fourth finger F4′ of the user, the second button 305 issues a second button code to the controlling unit 306. In this embodiment, the first blood vessel sensing unit 302 and the second blood vessel sensing unit 303 are embedded within the operating plate 301, so that the first blood vessel sensing unit 302 and the second blood vessel sensing unit 303 are at the same level with the flat surface of the operating plate 301. Under this circumstance, the top surface of the operating plate 301 may be maintained flat.

The controlling unit 306 is disposed within the operating plate 301. In addition, the controlling unit 306 is electrically connected with the first blood vessel sensing unit 302, the second blood vessel sensing unit 303, the first button 304 and the second button 305. When the first button 304 is pressed and the first button code is received by the controlling unit 306, a first button signal S1 corresponding to the first button code is transmitted from the controlling unit 306 to the computer host 31. According to the first button signal S1, the computer host 31 executes a first button command. When the second button 305 is pressed and the second button code is received by the controlling unit 306, a second button signal S2 corresponding to the second button code is transmitted from the controlling unit 306 to the computer host 31. According to the second button signal S2, the computer host 31 executes a second button command. In an embodiment, the first button command is a left button command, and the second button command is a right button command. The controlling unit 306 is a firmware component disposed within the operating plate 301. According to the plural blood vessel images of the first finger F1′ from the first blood vessel sensing unit 302 and the plural blood vessel images of the second finger F2′ from the second blood vessel sensing unit 303, the controlling unit 306 performs corresponding operations. The contents of the corresponding operations will be illustrated later.

Please refer to FIGS. 4 and 5. FIG. 5 schematically illustrates a first blood vessel sensing unit of the cursor control device according to the first embodiment of the present invention. As shown in FIG. 5, the first blood vessel sensing unit 302 comprises a first light-emitting element 3021 and a first image sensor 3022. The first blood vessel sensing unit 302 is used for emitting a first infrared light beam L1 to a user's finger. The first image sensor 3022 is connected with the controlling unit 306 for receiving the first infrared light beam L1 that is reflected from the user's finger, thereby acquiring the plural blood vessel images of the user's finger. In this embodiment, the first light-emitting element 3021 is an infrared light source for emitting the first infrared light beam L1 having an emission wavelength in the range between 700 nanometers and 10 millimeters.

Please refer to FIG. 4. When the palm P′ of the user is placed on the operating plate 301 according to the palm pattern 3011, the first finger F1′ is located at a first position P1 of the operating plate 301, and the second finger F2′ is located at a third position P3 of the operating plate 301. The first position P1 is disposed on the first blood vessel sensing unit 302, and the third position P3 is disposed on the second blood vessel sensing unit 303.

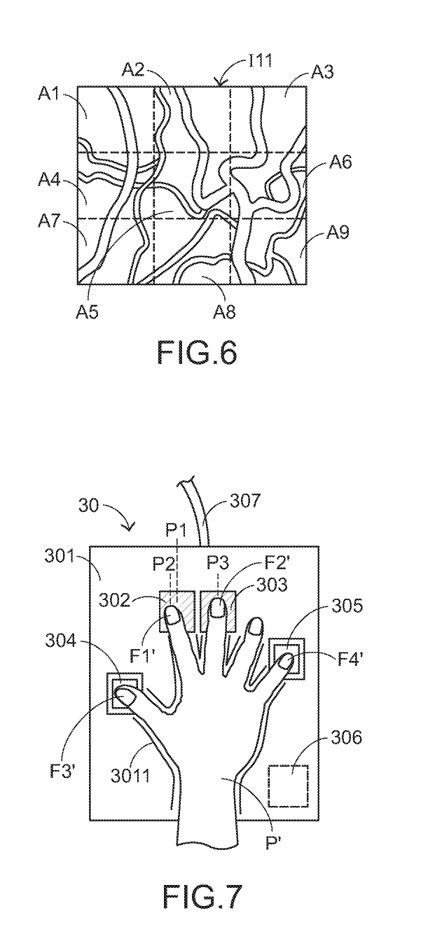

After the first finger F1′ is located at the first position P1 of the operating plate 301 and the first blood vessel sensing unit 302 is enabled, the first infrared light beam L1 from the first light-emitting element 3021 is projected on the first finger F1′. Consequently, a first portion of the first infrared light beam L1 within a first wavelength range is absorbed by the plural first blood vessels V1′ of the first finger F1′. On the other hand, a second portion of the infrared light beam L1 beyond the first wavelength range is reflected from the plural first blood vessels V1′. In this embodiment, the first wavelength range is between 700 nanometers and 1000 nanometers. After the second portion of the first infrared light beam L1 reflected from the first finger F1′ is received by the first image sensor 3022, the first image sensor 3022 generates a first blood vessel image I11 of the first finger F1′. The first blood vessel image I11 of the first finger F1′ is acquired when the first finger F1′ at the first position P1 is detected by the first blood vessel sensing unit 302. Moreover, the first blood vessel image I11 is imaged according to the absorbed portion of the first infrared light beam L1 within the first wavelength range. As shown in FIG. 6, the first blood vessel image I11 shows the distribution of the plural first blood vessels V1′ of the first finger F1′.

Similar to the first blood vessel sensing unit 302, the second blood vessel sensing unit 303 comprises a second light-emitting element (not shown) and a second image sensor (not shown). After the second finger F2′ of the user is located at the third position P3 of the operating plate 301 and the second blood vessel sensing unit 303 is enabled, the operations of the second blood vessel sensing unit 303 are similar to those of the first blood vessel sensing unit 302. Consequently, a third blood vessel image (not shown) of the second finger F2′ is generated by the second blood vessel sensing unit 303. The third blood vessel image of the second finger F2′ is acquired when the second finger F2′ at the third position P3 is detected by the second blood vessel sensing unit 303.

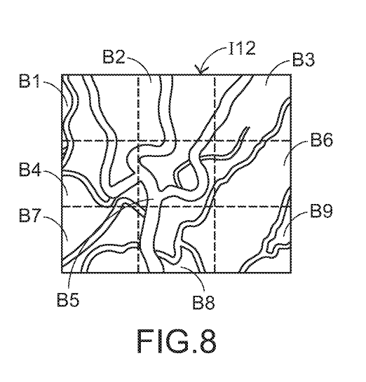

Hereinafter, a method of operating the cursor control device 30 to move the cursor 322 will be illustrated with reference to FIGS. 7 and 8. FIG. 7 schematically illustrates the hand gesture of operating the cursor control device according to the first embodiment of the present invention, in which the first finger is moved to a second position. FIG. 8 schematically illustrates a second blood vessel image of a first finger acquired by a first blood vessel sensing unit of the cursor control device according to the first embodiment of the present invention. In a case that the first finger F1′ of the user is moved along a first direction (e.g. a left direction) from the first position P1 and then the first finger F1′ is located at a second position P2, the above operations of the first blood vessel sensing unit 302 are performed to generate a second blood vessel image I12 of the first finger F1′ (see FIG. 8). Then, the first blood vessel image I11 and the second blood vessel image I12 of the first finger F1′ are transmitted from the first blood vessel sensing unit 302 to the controlling unit 306. By comparing the first blood vessel image I11 with the second blood vessel image I12, the controlling unit 306 acquires a first finger displacement amount D1 of the first finger F1′. The first finger displacement amount D1 denotes a distance between the first position P1 and the second position P2.

Hereinafter, a method of comparing the first blood vessel image I11 with the second blood vessel image I12 by the controlling unit 306 will be illustrated with reference to FIG. 6 and FIG. 8. For comparing the first blood vessel image I11 with the second blood vessel image I12 by the controlling unit 306, the first blood vessel image I11 is firstly segmented into plural image blocks A1˜A9 by the controlling unit 306. Then, the image block with the highest fraction of the first blood vessels V1′ is selected from the plural image blocks A1˜A9. Moreover, after the infrared light beam is absorbed by the red blood cells contained in the first blood vessels V1′, the contours of the first blood vessels V1′ will be imaged. Consequently, the image block of the first blood vessel image I11 with the lowest brightness value is the image block which absorbs the highest percentage of the infrared light beam. In other words, the image block of the first blood vessel image I11 with the lowest brightness value is the image block with the highest fraction of the first blood vessels V1′. Then, by comparing the brightness values of the plural image blocks A1˜A9 with each other, the controlling unit 306 selects the image block A6 with the lowest brightness value as a reference image block from the plural image blocks A1˜A9. That is, the image block A6 is the image block with the highest fraction of the first blood vessels V1′.

After the reference image block A6 of the first blood vessel image I11 is selected, the second blood vessel image I12 is segmented into plural image blocks B1˜B9 by the controlling unit 306. Then, the image block identical to the reference image block A6 is searched from the second blood vessel image I12. As shown in FIG. 6 and FIG. 8, the image block B5 is identical to the reference image block A6. By calculating the distance between the image block A6 of the first blood vessel image I11 and the image block B5 of the second blood vessel image I12, the first finger displacement amount D1 is acquired by the controlling unit 306. The direction of the vector pointing from the image block A6 to the image block B5 is the first direction (i.e. the left direction). Consequently, the direction of moving the first finger F1′ is realized by the controlling unit 306.

In the cursor control device 30, the first finger displacement amount D1 (e.g. 10 millimeters) is converted into a corresponding cursor moving signal S3 by the controlling unit 306. In addition, the cursor moving signal S3 is transmitted from the controlling unit 306 to the computer host 31 by the connecting wire 307. According to the cursor moving signal S3, the cursor 322 is moved by the computer host 31. In this embodiment, the moving distance of the cursor 322 is equal to the distance of the first finger displacement amount D1. The operating principle of moving the second finger F2′ on the second blood vessel sensing unit 303 to scroll the graphic-based window 321 is similar to the operating principle of moving the cursor 322, and is not redundantly described herein. According to the finger displacement amount of the second finger F2′, a corresponding window scrolling signal S4 is transmitted from the controlling unit 306 to the computer host 31. According to the window scrolling signal S4, the graphic-based window 321 is scrolled by the computer host 31.

From the above discussions, during operations of the cursor control device 30, the controlling unit 306 may correspondingly generates the first button signal S1, the second button signal S2, the cursor moving signal S3 or the window scrolling signal S4. In other words, the user may operate the cursor control device 30 to control the computer host 31 to execute the left button command, the right button command, the cursor moving command or the window scrolling command.

In this embodiment, according to the settings of the controlling unit 306, the movement of the cursor 322 along various directions is controlled in response to the motion of the first finger F1′, and the upward or downward scrolling action of the graphic-based window 321 is controlled in response to the motion of the second finger F2′, wherein the moving direction of the cursor 322 is correlated with the moving direction of the first finger F1′. Alternatively, in some other embodiments, the settings of the controlling unit 306 may be altered. For example, the movement of the cursor is controlled in response to the motions of two fingers, and the scrolling action of the graphic-based window is controlled in response to the motion of a third finger. For example, the action of moving the cursor along the left direction or the right direction is controlled in response to the action of moving the first finger along the left direction or the right direction, and the action moving the cursor along the upward direction or the downward direction is controlled in response to the action of moving the second finger along the left direction or the right direction.

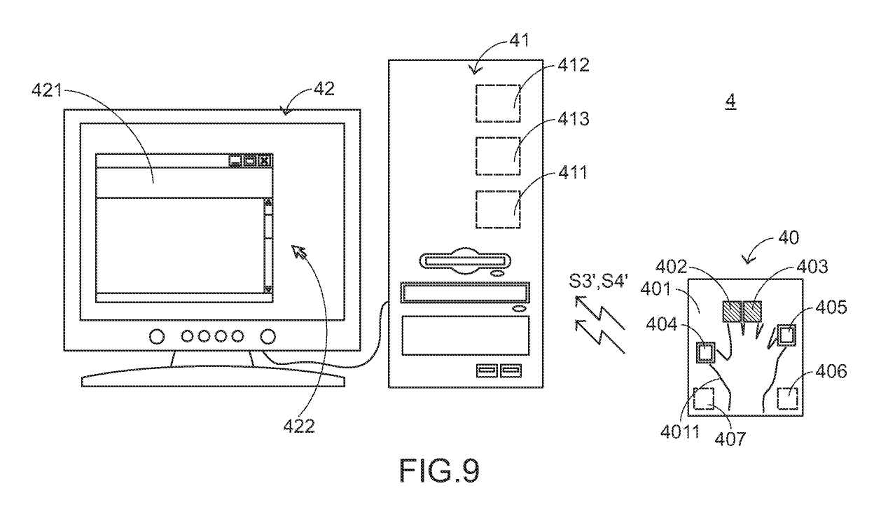

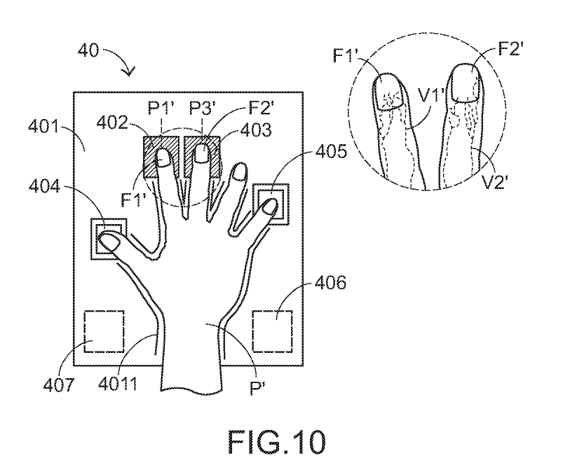

The present invention further provides a cursor control system. FIG. 9 schematically illustrates a cursor control device and a computer host of a cursor control system according to a second embodiment of the present invention. FIG. 10 schematically illustrates the hand gesture of operating the cursor control device according to the second embodiment of the present invention, in which a first finger is at a first position and a second finger is at a third position. Please refer to FIGS. 9 and 10. The cursor control system 4 comprises a cursor control device 40, a computer host 41, and a computer monitor 42. The computer host 41 is in communication with the cursor control device 40 and the computer monitor 42. The computer host 41 comprises a first wireless transmission module 411. In addition, a database program 412 is installed in the computer host 41. The first wireless transmission module 411 is in communication with the cursor control device 40 by a wireless transmission technology. By executing the database program 412, a finger database 413 is established within the computer host 41. A graphic-based window 421 and a cursor 422 are shown on the computer monitor 42.

The cursor control device 40 is used for controlling the graphic-based window 421 and a cursor 422 shown on the computer monitor 42. In this embodiment, the cursor control device 40 comprises an operating plate 401, a first blood vessel sensing unit 402, a second blood vessel sensing unit 403, a first button 404, a second button 405, a controlling unit 406, and a second wireless transmission module 407. The second wireless transmission module 407 is disposed within the operating plate 401. After the second wireless transmission module 407 is in communication with the first wireless transmission module 411 of the computer host 41, the cursor control device 40 is in communication with the computer host 41. In this embodiment, the first wireless transmission module 411 and the second wireless transmission module 407 are in communication with each other by a Bluetooth transmission technology. The configurations of the other components of the cursor control device 40 are substantially identical to those of the cursor control device 30 of the first embodiment, and are not redundantly described herein.

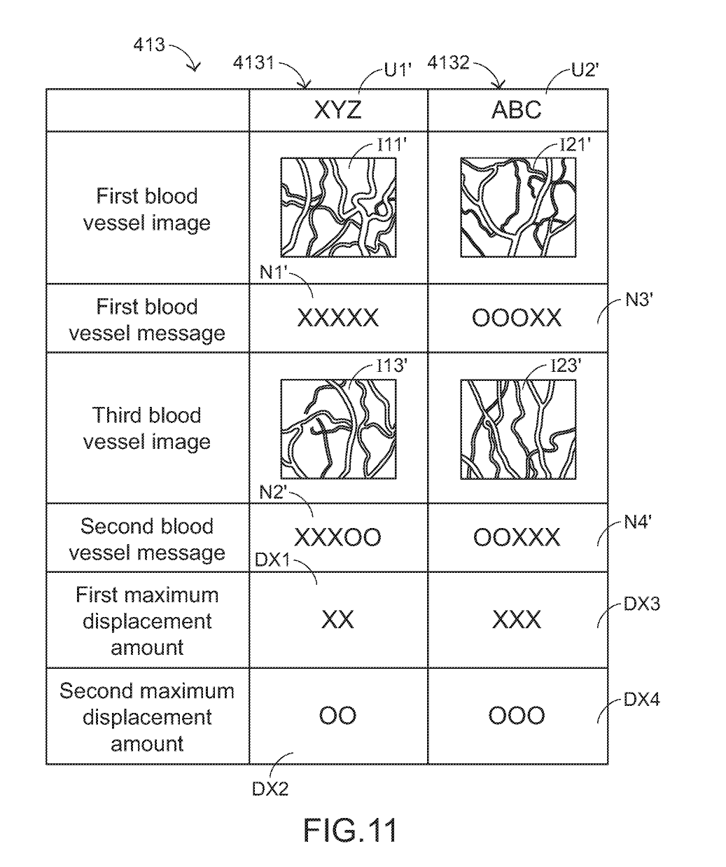

FIG. 11 schematically illustrates a finger database of the cursor control device according to the second embodiment of the present invention. In the cursor control system 4, the finger database 413 is established by executing the database program 412. As shown in FIG. 11, a first column 4131 of the finger database 413 comprises the following contents: a user code U1′, a first blood vessel image I11′, a first blood vessel message N1′, a third blood vessel image I13′, a second blood vessel message N2′, a first maximum displacement amount DX1, and a second maximum displacement amount DX2.

A process of establishing the finger database 413 by the database program 412 will be illustrated in more details as follows. Please refer to FIG. 10 again. When the palm P′ of the user is placed on the operating plate 401 according to the palm pattern 4011, the first finger F1′ is located at a first position P1′ of the operating plate 401, and the second finger F2′ is located at a third position P3′ of the operating plate 401. The first position P1′ is disposed on the first blood vessel sensing unit 402, and the third position P3′ is disposed on the second blood vessel sensing unit 403.

Then, the first blood vessel sensing unit 402 and the second blood vessel sensing unit 403 are enabled to perform the above operations as described in the first embodiment. Consequently, the first blood vessel image I11′ of the first finger F1′ (see FIG. 11) and the third blood vessel image I13′ of the second finger F2′ (see FIG. 11) are acquired by the first blood vessel sensing unit 402 and the second blood vessel sensing unit 403, respectively. The first blood vessel image I11′ shows the distribution of the plural first blood vessels V1′ of the first finger F1′. The third blood vessel image I13′ shows the distribution of the plural second blood vessels V2′ of the second finger F2′. The first blood vessel image I11′ of the first finger F1′ is acquired when the first finger F1′ at the first position P1′ is detected. The third blood vessel image I13′ of the second finger F2′ is acquired when the second finger F2′ at the third position P3′ is detected.

After the first blood vessel image I11′ of the first finger F1′ and the third blood vessel image I13′ of the second finger F2′ are generated, the first blood vessel image I11′ of the first finger F1′ and the third blood vessel image I13′ of the second finger F2′ are transmitted from the controlling unit 406 to the computer host 41 through the first wireless transmission module 411 and the second wireless transmission module 407. After the first blood vessel image I11′ of the first finger F1′ and the third blood vessel image I13′ of the second finger F2′ are transmitted to the computer host 41, the database program 412 analyzes the first blood vessel image I11′ of the first finger F1′ to acquire the first blood vessel message N1′ corresponding to the first blood vessel image I11′ and analyzes the third blood vessel image I13′ of the second finger F2′ to acquire the second blood vessel message N2′ corresponding to the third blood vessel image I13′. The first blood vessel message N1′ indicates the distribution of the plural first blood vessels V1′ shown on the first blood vessel image I11′. The second blood vessel message N2′ indicates the distribution of the plural second blood vessels V2′ of the third blood vessel image I13′.

Then, the database program 412 assigns the user code U1′ to the first blood vessel message N1′ and the second blood vessel message N2′. In addition, the user code U1′, the first blood vessel image I11′ of the first finger F1′, the first blood vessel message N1′, the third blood vessel image I13′ of the second finger F2′ and the second blood vessel message N2′ are stored into the finger database 413. The messages of the finger database 413 corresponding to the user include the user code U1′, the first blood vessel image I11′, the first blood vessel message N1′, the third blood vessel image I13′ and the second blood vessel message N2′. In addition, as shown in FIG. 11, these messages are displayed on the first column 4131 of the finger database 413.

After the palm P′ is placed on the operating plate 401 and before the cursor control device 40 is operated, some of the finger messages of the user have been acquired by the finger database 413. As mentioned above, these finger messages comprise the user code U1′, the first blood vessel image I11′, the first blood vessel message N1′, the third blood vessel image I13′ and the second blood vessel message N2′. A process of acquiring the first maximum displacement amount DX1 and the second maximum displacement amount DX2 by the cursor control system 4 will be illustrated in more details as follows.

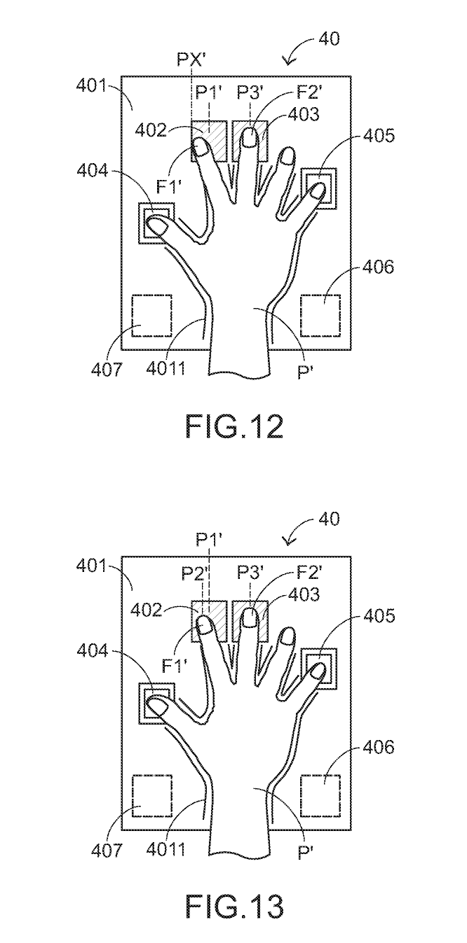

Please refer to FIG. 10 and FIG. 12. FIG. 12 schematically illustrates the hand gesture of operating the cursor control device according to the second embodiment of the present invention, in which the first finger is moved to a terminal position. Before the cursor control device 40 is normally operated, the first finger F1′ of the user is moved along a first direction (e.g. a left direction) from the first position P1′ and then the first finger F1′ is located at a terminal position PX′. The terminal position PX′ denotes the maximum reachable position of moving the first finger F1′ along the first direction from the first position P1′ while maintaining the palm P′ immobile. The above operations of the first blood vessel sensing unit 402 are performed to generate a terminal blood vessel image of the first finger F1′ (not shown). The terminal blood vessel image of the first finger F1′ is acquired when the first finger F1′ at the terminal position PX′ is detected.

Then, the first blood vessel image I11′ of the first finger F1′ is compared with the terminal blood vessel image of the first finger F1′ by the controlling unit 406. After the above comparing process as described in the first embodiment is performed, the first maximum displacement amount DX1 (e.g. 25 millimeters) is acquired by the controlling unit 406. The first maximum displacement amount DX1 denotes a distance between the first position P1′ and the terminal position PX′. On the other hand, a predetermined cursor movement distance (e.g. 500 millimeters) is previously stored in the controlling unit 406. After the first maximum displacement amount DX1 is acquired by the controlling unit 406, the predetermined cursor movement distance is assigned to the first maximum displacement amount DX1 by the controlling unit 406. Consequently, in a case that the first finger F1′ is moved on the first blood vessel sensing unit 402 for the first maximum displacement amount DX1 (i.e. 25 millimeters), the cursor moving signal S3′ corresponding to the predetermined cursor movement distance is transmitted from the controlling unit 406 to the computer host 41. According to the cursor moving signal S3′, the cursor 422 is moved by the computer host 41, wherein the moving distance of the cursor 422 is equal to the predetermined cursor movement distance (e.g. 500 millimeters). That is, although the moving distance of the first finger F1′ is very small, the moving distance of the cursor 422 is munch longer than the moving distance of the first finger F1′. Consequently, the cursor control device 40 can be operated more smoothly.

After the first maximum displacement amount DX1 is acquired, the first maximum displacement amount DX1 is transmitted from the controlling unit 406 to the computer host 41. In addition, as shown in FIG. 11, the first maximum displacement amount DX1 is stored in the first column 4131 of the finger database 413 by the database program 412. The way of acquiring the second maximum displacement amount DX2 is similar to the way of acquiring the first maximum displacement amount DX1, and is not redundantly described herein. Under this circumstance, a predetermined window movement distance is assigned to the second maximum displacement amount DX2 by the controlling unit 406. That is, although the moving distance of the second finger F2′ is very small, the moving distance of the graphic-based window 421 is munch longer than the moving distance of the second finger F2′.

Hereinafter, a method of operating the cursor control device 40 will be illustrated with reference to FIGS. 10 and 13. FIG. 13 schematically illustrates the hand gesture of operating the cursor control device according to the second embodiment of the present invention, in which the first finger is moved to a second position. In a case that the first finger F1′ of the user is moved along a first direction (e.g. a left direction) from the first position P1′ and then the first finger F1′ is located at a second position P2′, the above operations of the first blood vessel sensing unit 402 are performed to generate a second blood vessel image of the first finger F1′ (not shown). The second blood vessel image of the first finger F1′ is acquired when the first finger F1′ at the second position P2′ is detected.

After the first blood vessel image I11′ of the first finger F1′ and the second blood vessel image are transmitted to the controlling unit 406, by comparing the first blood vessel image I11′ with the second blood vessel image, the controlling unit 406 acquires a first finger displacement amount (e.g. 10 millimeter) of the first finger F1′. After the first finger displacement amount is acquired, the controlling unit 406 compares the first finger displacement amount with the first maximum displacement amount DX1 (i.e. 25 millimeters), thereby acquiring a first displacement ratio. The first displacement ratio is a quotient of dividing the first finger displacement amount by the first maximum displacement amount DX1. That is, the first displacement ratio=the first finger displacement amount/the first maximum displacement amount DX1.

After calculation, it is found that the first displacement ratio is 0.25. Then, the first displacement ratio is multiplied by the predetermined cursor movement distance (i.e. 500 millimeters), so that a cursor moving signal S3′ corresponding to the first finger displacement amount is acquired by the controlling unit 406. In addition, the cursor moving signal S3′ corresponding to the first finger displacement amount is transmitted from the controlling unit 406 to the computer host 41. According to the cursor moving signal S3′, the cursor 422 is moved by the computer host 41, wherein the cursor 422 shown on the computer monitor 42 is moved along the left direction and the moving distance of the cursor 422 is equal to 125 millimeters (i.e. 500 mm×0.25=125 mm).

The operating principle of moving the second finger F2′ on the second blood vessel sensing unit 403 to scroll the graphic-based window 421 is similar to the operating principle of moving the cursor 422. In a case that the second finger F2′ of the user is moved along a second direction (e.g. a downward direction) perpendicular to the first direction from the third position P3′ and then the second finger F2′ is located at a fourth position (not shown), the above operations of the second blood vessel sensing unit 403 are performed to generate a fourth blood vessel image of the second finger F2′ (not shown). Then, according to the third blood vessel image and the fourth blood vessel image of the second finger F2′, a second finger displacement amount of the second finger F2′ is acquired by the controlling unit 406. After the second finger displacement amount is acquired, the controlling unit 406 compares the second finger displacement amount with the second maximum displacement amount DX2, thereby acquiring a second displacement ratio.

Then, the second displacement ratio is multiplied by the predetermined cursor movement distance, so that a window scrolling signal S4′ corresponding to the second finger displacement amount is acquired by the controlling unit 406. In addition, the window scrolling signal S4′ corresponding to the second finger displacement amount is transmitted from the controlling unit 406 to the computer host 41. According to the window scrolling signal S4′, the graphic-based window 421 is correspondingly scrolled.

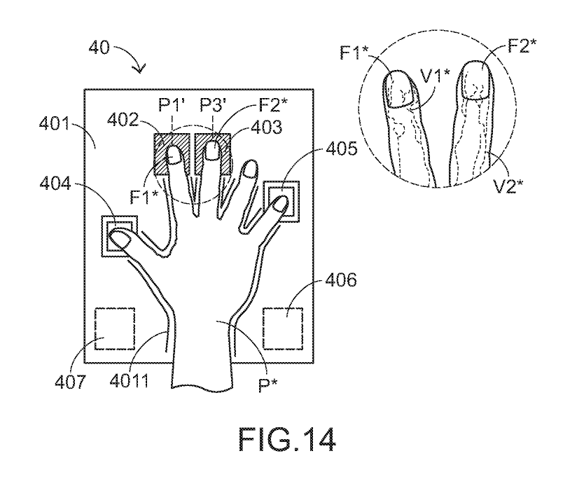

Hereinafter, the operation of the cursor control device 40 by an additional user at a first time will be illustrated with reference to FIG. 14. FIG. 14 schematically illustrates the hand gesture of an additional user of operating the cursor control device according to the second embodiment of the present invention. When the palm P* of the additional user is placed on the operating plate 401 according to the palm pattern 4011, a first finger F1* of the additional user is located at the first position P1′ of the operating plate 401, and a second finger F2* of the additional user is located at a third position P3′ of the operating plate 401. The first position P1′ is disposed on the first blood vessel sensing unit 402, and the third position P3′ is disposed on the second blood vessel sensing unit 403. Then, the first blood vessel sensing unit 402 is enabled to detect the first finger F1* of the additional user, thereby acquiring a first blood vessel image I21′ of the first finger F1* of the additional user (see FIG. 11). The first blood vessel image I21′ shows the distribution of the plural first blood vessels V1* of the first finger F1* of the additional user. At the same time, the second blood vessel sensing unit 403 is enabled to detect the second finger F2* of the additional user, thereby acquiring a third blood vessel image I23′ of the second finger F2* of the additional user (see FIG. 11). The third blood vessel image I23′ shows the distribution of the plural first blood vessels V2* of the second finger F2* of the additional user.

After the first blood vessel image I21′ of the first finger F1* and the third blood vessel image I23′ of the second finger F2* are generated, the first blood vessel image I21′ of the first finger F1* and the third blood vessel image I23′ of the second finger F2* are transmitted from the controlling unit 406 to the computer host 41 by a wireless transmission technology. After the first blood vessel image I21′ of the first finger F1* and the third blood vessel image I23′ of the second finger F2* are transmitted to the computer host 41, the database program 421 analyzes the first blood vessel image I21′ of the first finger F1* to acquire a third blood vessel message N3′ corresponding to the first blood vessel image I21′ and analyzes the third blood vessel image I23′ of the second finger F2* to acquire a fourth blood vessel message N4′ corresponding to the third blood vessel image I23′. The third blood vessel message N3′ indicates the distribution of the plural first blood vessels V1* shown on the first blood vessel image I21′. The fourth blood vessel message N4′ indicates the distribution of the plural second blood vessels V2* of the third blood vessel image I23′.

Then, the database program 412 assigns an additional user code U2′ to the third blood vessel message N3′ and the fourth blood vessel message N4′. In addition, the additional user code U2′, the first blood vessel image I21′ of the first finger F1*, the third blood vessel message N3′, the third blood vessel image I23′ of the second finger F2* and the fourth blood vessel message N4′ are stored into the finger database 413. The messages of the finger database 413 corresponding to the additional user includes the additional user code U2′, the first blood vessel image I21′ of the first finger F1*, the third blood vessel message N3′, the third blood vessel image I23′ of the second finger F2* and the fourth blood vessel message N4′. In addition, as shown in FIG. 11, these messages are displayed on a second column 4132 of the finger database 413. The process of acquiring a third maximum displacement amount DX3 and the process of acquiring a fourth maximum displacement amount DX4 are similar to the process of acquiring the first maximum displacement amount DX1, and are not redundantly described herein.

From the above discussions, the cursor control system 4 of the present invention is capable of collecting the finger messages of different users by establishing the finger database 413. In a case that the user with the filed messages operates the cursor control device 40 again, the database program 412 may compare the currently-detected first blood vessel image of the first finger with the plural first blood vessel images stored in the finger database 413. Once the database program 412 judges that the currently-detected first blood vessel image of the first finger complies with a specified first blood vessel image corresponding to a specified user, the first maximum displacement amount DX1 and the second maximum displacement amount DX2 corresponding to the specified user will be transmitted from the database program 412 to the controlling unit 406 in order to be utilized by the controlling unit 406. Under this circumstance, it is not necessary to perform again the task of assigning the predetermined cursor movement distance to the first maximum displacement amount DX1 or the task of assigning the predetermined window movement distance to the second maximum displacement amount DX2. Consequently, the time period of establishing the finger database 413 is saved. On the other hand, if a new user without the filed messages operates the cursor control device 40 at a first time, the detected messages corresponding to the new user may be stored in the finger database 413. The messages corresponding to the new user may facilitate this user to operate the cursor control device 40 at a later time.

It is noted that the predetermined cursor movement distance and the predetermined window movement distance previously stored in the controlling unit may be modified by a programming compiler. Consequently, the sensitivity of moving the cursor of scrolling the window may be adjusted according to the requirements of different users.

From the above descriptions, the present invention provides a cursor control device and a cursor control system. The cursor control device has a flat operating plate. The whole palm of the user may lie flat on the flat operating plate to operate the cursor control device without the need of maintaining a floating state of the user's wrist to operate the cursor control device. Consequently, the possibility of causing the wrist fatigue or the wrist muscle injury will be minimized, and the wrist fatigue can be effectively relieved. Moreover, since the cursor control system has a finger database to store the finger messages of different users, the finger messages may facilitate different users to operate the cursor control device at a later time.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cursor control device in communication with a computer host for controlling a cursor of said computer host, said cursor control device comprising:
an operating plate for placing a palm and a first finger of a user thereon, wherein said first finger comprises plural first blood vessels;
a first blood vessel sensing unit disposed on said operating plate for detecting said first finger at different positions, thereby acquiring plural blood vessel images of said first finger, wherein a first blood vessel image of said plural blood vessel images of said first finger is acquired by said first blood vessel sensing unit when said first finger at a first position is detected, wherein a second blood vessel image of said plural blood vessel images of said first finger is acquired by said first blood vessel sensing unit when said first finger at a second position is detected; and
a controlling unit disposed within said operating plate and connected with said first blood vessel sensing unit, wherein said controlling unit acquires a first finger displacement amount of said first finger according to said first blood vessel image of said first finger and said second blood vessel image of said first finger, wherein a cursor moving signal is generated by said controlling unit according to said first finger displacement amount, and said cursor is moved by said computer host according to said cursor moving signal.

2. The cursor control device according to claim 1, wherein said first blood vessel sensing unit comprises:
a first light-emitting element for emitting a first infrared light beam to said first finger; and
a first image sensor connected with said controlling unit for receiving said first infrared light beam reflected from said first finger, thereby acquiring said plural blood vessel images of said first finger, wherein when said first finger is at said first position and said first infrared light beam is projected on said first finger, a first portion of said first infrared light beam within a first wavelength range is absorbed by said plural first blood vessels of said first finger, and a second portion of said first infrared light beam beyond said first wavelength range is reflected from said plural first blood vessels of said first finger, wherein after said second portion of said first infrared light beam reflected from said plural first blood vessels of said first finger is received by said first image sensor, said first blood vessel image of said first finger is produced by said first image sensor, wherein said first blood vessel image of said first finger is imaged according to said absorbed first portion of said first infrared light beam within said first wavelength range.

3. The cursor control device according to claim 2, wherein when said first finger is moved from said first position to said second position along a first direction and said first blood vessel image of said first finger and said second blood vessel image of said first finger are generated by said first image sensor, said controlling unit acquires said first finger displacement amount corresponding to said first direction by comparing said first blood vessel image of said first finger with said second blood vessel image of said first finger, and said controlling unit generates said cursor moving signal corresponding to said first direction.

4. The cursor control device according to claim 2, wherein when said first finger is moved from said first position to said second position along a first direction and said first blood vessel image of said first finger and said second blood vessel image of said first finger are generated by said first image sensor, said controlling unit acquires said first finger displacement amount corresponding to said first direction by comparing said first blood vessel image of said first finger with said second blood vessel image of said first finger, and said controlling unit generates said cursor moving signal corresponding to a second direction, wherein said second direction is perpendicular to said first direction.

5. The cursor control device according to claim 1, further comprising a second blood vessel sensing unit, wherein said second blood vessel sensing unit is disposed on said operating plate and located beside said first blood vessel sensing unit for detecting a second finger of said user at different positions, thereby acquiring plural blood vessel images of said second finger, wherein a third blood vessel image of said plural blood vessel images of said second finger is acquired by said second blood vessel sensing unit when said second finger at a third position is detected, wherein a fourth blood vessel image of said plural blood vessel images of said second finger is acquired by said second blood vessel sensing unit when said second finger at a fourth position is detected.

6. The cursor control device according to claim 5, wherein said controlling unit is further connected with said second blood vessel sensing unit, wherein said controlling unit acquires a second finger displacement amount of said second finger by comparing said third blood vessel image of said second finger with said fourth blood vessel image of said second finger, wherein a window scrolling signal is generated by said controlling unit according to said second finger displacement amount, and a window scrolling command is executed by said computer host according to said window scrolling signal, wherein said second blood vessel sensing unit comprises:
a second light-emitting element for emitting a second infrared light beam to said second finger; and
a second image sensor connected with said controlling unit for receiving said second infrared light beam reflected from said second finger, thereby acquiring said plural blood vessel images of said second finger, wherein when said second finger is at said third position and said second infrared light beam is projected on said second finger, a first portion of said second infrared light beam within a first wavelength range is absorbed by said plural second blood vessels of said second finger, and a second portion of said second infrared light beam beyond said first wavelength range is reflected from said plural second blood vessels of said second finger, wherein after said second portion of said second infrared light beam reflected from said plural second blood vessels of said second finger is received by said second image sensor, said third blood vessel image of said second finger is produced by said second image sensor, wherein said third blood vessel image of said second finger is imaged according to said absorbed first portion of said second infrared light beam within said second wavelength range.

7. The cursor control device according to claim 1, further comprising:
a first button disposed on said operating plate and electrically connected with said controlling unit, wherein when said first button is pressed by a third finger of said user, said first button issues a first button code to said controlling unit; and
a second button disposed on said operating plate and electrically connected with said controlling unit, wherein when said second button is pressed by a fourth finger of said user, said second button issues a second button code to said controlling unit, wherein when said first button code is received by said controlling unit, a first button signal corresponding to said first button code is transmitted from said controlling unit to said computer host, so that said computer host executes a first button command according to said first button signal, wherein when said second button code is received by said controlling unit, a second button signal corresponding to said second button code is transmitted from said controlling unit to said computer host, so that said computer host executes a second button command according to said second button signal.

8. A cursor control system, comprising:
a computer host with a cursor, wherein a database program is installed in said computer host, and a finger database is established within said computer host by executing said database program; and
a cursor control device in communication with said computer host for controlling said cursor, wherein said cursor control device comprises:
an operating plate for placing a palm and a first finger of a user thereon, wherein said first finger comprises plural first blood vessels;
a first blood vessel sensing unit disposed on said operating plate for detecting said first finger at different positions, thereby acquiring plural blood vessel images of said first finger, wherein a first blood vessel image of said plural blood vessel images of said first finger is acquired by said first blood vessel sensing unit when said first finger at a first position is detected; and
a controlling unit disposed within said operating plate and connected with said first blood vessel sensing unit and said computer host, wherein said controlling unit issues a cursor moving signal to said computer host according to said plural blood vessel images of said first finger, so that said cursor is moved by said computer host according to said cursor moving signal, or said controlling unit transmits said first blood vessel image of said first finger to said computer host, wherein after said first blood vessel image of said first finger is received by said computer host, said database program analyzes said first blood vessel image of said first finger to acquire a blood vessel message corresponding to said first blood vessel image, and said database program assigns a user code to said blood vessel message, wherein said user code and said blood vessel message are further stored in said finger database.

9. The cursor control system according to claim 8, wherein a second blood vessel image of said plural blood vessel images of said first finger is acquired by said first blood vessel sensing unit when said first finger at a second position is detected, wherein said controlling unit acquires a first finger displacement amount of said first finger by comparing said first blood vessel image of said plural blood vessel images with said second blood vessel image, wherein said cursor moving signal is generated by said controlling unit according to said first finger displacement amount, and said cursor is moved by said computer host according to said cursor moving signal.

10. The cursor control system according to claim 9, wherein a predetermined cursor movement distance is previously stored in said controlling unit, wherein when said first finger is moved from said first position to a terminal position along a first direction and a terminal blood vessel image of said first finger is acquired by said first blood vessel sensing unit, said controlling unit acquires a maximum displacement amount by comparing said first blood vessel image of said first finger with said terminal blood vessel image of said first finger, and said controlling unit assigns said predetermined cursor movement distance to said maximum displacement amount, wherein after said first finger displacement amount is acquired by said controlling unit, said controlling unit compares said first finger displacement amount with said maximum displacement amount, thereby acquiring a displacement ratio, and said controlling unit acquires said cursor moving signal according to said displacement ratio and said predetermined cursor movement distance.

11. The cursor control system according to claim 8, wherein said cursor control device further comprises a second blood vessel sensing unit, wherein said second blood vessel sensing unit is disposed on said operating plate and located beside said first blood vessel sensing unit, and said second blood vessel sensing unit is connected with said controlling unit for detecting a second finger of said user at different positions, thereby acquiring plural blood vessel images of said second finger, wherein said controlling unit acquires a second finger displacement amount according to said plural blood vessel images of said second finger, wherein said controlling unit issues a window scrolling signal to said computer host according to said second finger displacement amount, and said computer host executes a window scrolling command according to said window scrolling signal, wherein a third blood vessel image of said plural blood vessel images of said second finger is acquired by said second blood vessel sensing unit when said second finger at a third position is detected, wherein a fourth blood vessel image of said plural blood vessel images of said second finger is acquired by said second blood vessel sensing unit when said second finger at a fourth position is detected.

12. The cursor control system according to claim 11, wherein a predetermined window movement distance is previously stored in said controlling unit, wherein when said second finger is moved from said third position to a terminal position along a first direction and a terminal blood vessel image of said second finger is acquired by said second blood vessel sensing unit, said controlling unit acquires a maximum displacement amount by comparing said third blood vessel image of said second finger with said terminal blood vessel image of said second finger, and said controlling unit assigns said predetermined window movement distance to said maximum displacement amount, wherein after said second finger displacement amount is acquired by said controlling unit, said controlling unit compares said second finger displacement amount with said maximum displacement amount, thereby acquiring a displacement ratio, and said controlling unit acquires said window scrolling signal according to said displacement ratio and said predetermined window movement distance.

13. The cursor control system according to claim 8, wherein when a first finger of an additional user at said first position is detected by said first blood vessel sensing unit, a first blood vessel image of said first finger of said additional user is acquired by said first blood vessel sensing unit, and said first blood vessel image of said first finger of said additional user is transmitted from said controlling unit to said computer host, wherein after said first blood vessel image of said first finger of said additional user is received by said computer host, said database program analyzes said first blood vessel image of said first finger of said additional user to acquire an additional blood vessel message corresponding to said additional blood vessel image of said first finger of said additional user, and said database program assigns an additional user code to said additional blood vessel message, wherein said additional user code and said additional blood vessel message are further stored in said finger database.
